(19) United States
(12) Patent Application Publication
(10) Pub. No.: US 2026/0122025 A1
(43) Pub. Date: Apr. 30, 2026

(54) SYSTEMS AND METHODS FOR QUEUING EXTERNAL COMMUNICATIONS USING INTERNAL LAMBDA FUNCTIONS

(71) Applicant: Capital One Services, LLC, McLean, VA (US)

(72) Inventor: Manikandan RAJARAM, Ashburn, VA (US)

(73) Assignee: Capital One Services, LLC, McLean, VA (US)

(21) Appl. No.: 18/927,814

(22) Filed: Oct. 25, 2024

(51) Int. Cl. H04L 51/222; H04L 51/04

(52) U.S. Cl. CPC H04L 51/222; H04L 51/04

(57) ABSTRACT

Systems and methods for the use of lambda functions for implementing rules for communication delivery times in cloud computing platforms. For example, lambda functions may implement rules for communication delivery times in cloud computing platforms due to their event-driven nature, scalability, and ease of integration with other platform services. Moreover, lambda functions can be triggered by a variety of events, such as scheduled tasks. By leveraging lambda functions, developers can implement logic that handles time zone calculations, respects local regulations, and adjusts for daylight saving changes, ensuring that communications are sent at the appropriate times.

### BACKGROUND

Communications are often sent during business hours to ensure timely and effective responses, as this is when most professionals are actively working and available. During business hours, employees are typically at their desks, monitoring their emails, phones, and other communication channels, which increases the likelihood of immediate attention and prompt action. This is particularly important for time-sensitive matters that require quick decisions or collaboration. Moreover, sending communications during business hours helps align with standard workflows and schedules, reducing the risk of messages being overlooked or delayed. It also fosters a professional environment by respecting work-life boundaries, ensuring that employees are not expected to respond to work-related communications during their personal time. Effective communication during business hours can enhance productivity, improve coordination, and maintain a healthy work-life balance for all involved.

Furthermore, some communications may be subject to rules and regulations about their transmission during business hours. For example, in the United States, the Fair Debt Collection Practices Act (FDCPA) outlines specific rules for debt collectors, including the permissible times for contact. According to the FDCPA, debt collectors can only communicate with consumers between 8 a.m. and 9 p.m. local time, unless the consumer agrees to other times. This regulation aims to prevent undue stress and harassment outside of reasonable hours. Additionally, the FDCPA prohibits debt collectors from contacting consumers at their place of employment if they are aware that such communications are not allowed by the employer. Similar regulations exist in other countries, often with specific provisions tailored to their legal and cultural contexts. These laws are enforced to ensure that debt collection practices are conducted ethically, respecting the consumer's privacy and personal time while allowing for the necessary recovery of debts.

### SUMMARY

Despite the benefits of limiting communications to particular times, doing so presents many technical challenges. For example, limiting communications to particular times of day can be technically challenging due to the complexities involved in accurately tracking and managing different time zones, especially for businesses that operate globally. Implementing these restrictions requires sophisticated scheduling systems that can handle various time zone calculations to ensure compliance with local regulations for each recipient. Additionally, these systems must account for daylight saving time changes, national holidays, and variations in local business hours, adding layers of complexity. Ensuring that communications are not sent outside of designated times necessitates robust programming and precise coordination between automated systems and human operators. Moreover, integrating these constraints into existing communication workflows and technologies can be resource-intensive, requiring updates to software, rigorous testing, and continuous monitoring to prevent inadvertent breaches. Overall, while the principle of limiting communications to specific times is straightforward, the practical implementation involves navigating a web of technical, regulatory, and operational challenges.

Moreover, existing communication workflows increasingly use cloud computing platforms, which provide a vast array of services and infrastructure solutions that enable businesses and developers to build, deploy, and/or manage applications and services in the cloud. However, the use of cloud computing platforms to implement rules for communication delivery times presents numerous technical problems.

For example, one significant difficulty lies in the inherent complexity of cloud environments, which often involve multiple integrated services, each with its own configuration and behavior. Coordinating these services to adhere to precise timing rules can be complex, requiring a deep understanding of how they interact and how timing rules can be enforced across different components. Moreover, users of cloud computing platforms may have limited ability to modify existing workflows of those platforms. Additionally, cloud platforms operate on a global scale, which means managing time zones, daylight saving changes, and regional compliance requirements becomes more complicated. Ensuring that communications are sent at the correct local time for each recipient involves sophisticated scheduling logic and careful synchronization across distributed systems. As yet another example, security and privacy concerns also play a role, as implementing strict communication delivery rules often requires access to sensitive user data, which must be handled in compliance with various regulations. Balancing the need for precise timing with the requirements for data protection can be technically challenging.

Systems and methods are described herein for novel uses and/or improvements to the use of lambda functions for implementing rules for communication delivery times in cloud computing platforms. For example, lambda functions may implement rules for communication delivery times in cloud computing platforms due to their event-driven nature, scalability, and ease of integration with other platform services. Moreover, lambda functions can be triggered by a variety of events, such as scheduled tasks. This flexibility allows for precise scheduling and execution of communication tasks based on specific timing rules. By leveraging lambda functions, developers can implement logic that handles time zone calculations, respects local regulations, and adjusts for daylight saving changes, ensuring that communications are sent at the appropriate times. Additionally, Lambda functions automatically scale in response to the number of incoming events, making them ideal for handling variable loads without the need for manual intervention or server management. This scalability ensures that communication rules are consistently enforced regardless of the volume of messages.

In some aspects, systems and methods are described herein for queuing external communications using internal lambda functions. For example, the system may receive, at a first lambda function, an internal communication corresponding to an external communication, wherein the external communication is for delivery to a first user account, wherein a time of delivery for the external communication is based on an external communication location. The system may determine, while the internal communication is pending at the first lambda function, an external communication location based on metadata for the external communication. The system may retrieve, while the internal communication is pending at the first lambda function, a first time zone identifier corresponding to the external communication location. The system may determine a processing time offset for the external communication based on the first time zone identifier. The system may queue, at the first lambda function, the external communication in an internal communication queue based on the processing time offset. The system may transmit, by the first lambda function, the external communication to the first user account.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for queuing external communications using internal lambda functions, in accordance with one or more embodiments.

FIG. 2 shows an illustrative lambda function for queuing external communications, in accordance with one or more embodiments.

FIG. 3 shows illustrative components for a system used to queue external communications, in accordance with one or more embodiments.

FIG. 4 shows a flowchart of the steps involved in queuing external communications using internal lambda functions, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

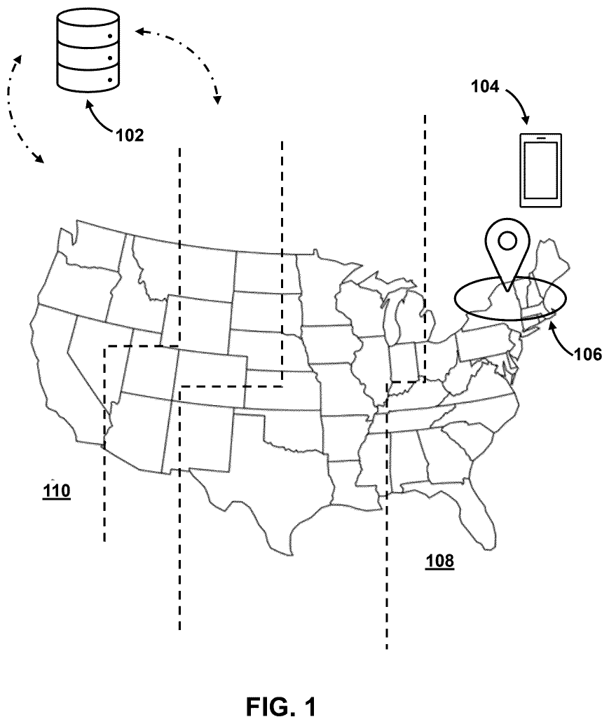

FIG. 1 shows an illustrative diagram for queuing external communications using internal lambda functions, in accordance with one or more embodiments. For example, FIG. 1 includes server 102 and user device 104. FIG. 1 may represent a situation when an external communication is sent to device 104, while device 104 is located in its external communication location (e.g., geographic region 106).

Server 102 may comprise one or more devices from a cloud computing platform. A cloud computing platform may comprise one or more devices. For example, a cloud computing platform may include a comprehensive suite of services provided over the internet that enables individuals and organizations to develop, deploy, manage, and scale applications and services without the need for on-premises infrastructure. These platforms offer a wide range of resources, including computing power, storage, databases, networking, analytics, machine learning, and more, all accessible on-demand and billed on a pay-as-you-go basis. By leveraging a cloud computing platform, users can quickly provision and utilize resources as needed, allowing for greater flexibility, scalability, and cost-efficiency compared to traditional IT infrastructure.

As referred to herein, an external communication or message may comprise any electronic communication. For example, electronic communications may encompass a wide range of methods used to transmit information digitally. Email is one of the most common types, allowing individuals and organizations to send messages, documents, and other files over the internet. Instant messaging is another type of communication that provides real-time text communication, often with additional features. Social media platforms (and/or communications therein) may also enable users to share updates, images, videos, and/or links, fostering both personal and professional interactions. Video conferencing tools may facilitate virtual face-to-face meetings, supporting features like screen sharing and virtual whiteboards. Additionally, SMS and MMS services enable text and multimedia messaging via mobile networks. Blogs, forums, and online discussion boards provide platforms for asynchronous communication, where users can post and respond to messages over time. Each of these electronic communication types serves different purposes and offers unique advantages, enabling effective and efficient information exchange in various contexts. The electronic communications (whatever the form) may provide various types of content.

As referred to herein, “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. As referred to herein, the term “multimedia” should be understood to mean content that utilizes at least two different content forms described above, for example, text, audio, images, video, or interactivity content forms. Content may be recorded, played, displayed, or accessed by user equipment devices, but can also be part of a live performance.

In some embodiments, a communication may have a predetermined and/or required delivery time. The system may determine delivery times (e.g., a time at which an electronic communication is delivered) based on the location of a user account and/or user device. In some embodiments, the system may determine a delivery time by using a combination of factors, including user preferences, time zone data, scheduling algorithms, and/or predefined rules or constraints. For example, the system may gather relevant information, such as the recipient's time zone, which can be obtained from their account settings, location data, or IP address. The system may also determine one or more delivery rules, user-defined preferences, and/or scheduling settings, which may specify preferred delivery windows or blackout periods when communications should not be sent. The system may also use one or more scheduling algorithms in determining the optimal delivery time. These algorithms can analyze the collected data and apply rules or constraints, such as avoiding delivery during weekends, holidays, and/or outside of business hours. For more complex scenarios, the system might incorporate artificial intelligence models that predict the best times to send communications, determine likely locations of users, and/or other characteristics based on historical data and user behavior patterns, optimizing for engagement or response rates. Once the optimal delivery time is calculated, the system may schedule the communication task accordingly, using built-in scheduling features of the cloud platform or external services like cron jobs. In some embodiments, a communication may be queued. These tasks are then monitored to ensure they are executed at the correct time, with contingency plans in place to handle any potential disruptions or delays.

For example, the system may receive, at a serverless computing service, an internal communication corresponding to an external communication, wherein the external communication is for delivery to a first user account at a first user device, wherein a time of delivery for the external communication is based on an external communication location, and wherein the external communication location is based on a current geographic location of the first user device. The system may then receive a first rule for delivery of the external communication. In response to receiving the internal communication, the system may execute a first lambda function using a first stateless container at the serverless computing service to enforce the first rule, wherein the first lambda function.

A location (e.g., geographic region 106) may refer to a particular place or position. The location may be defined by one or more characteristics that distinguish it from other locations. For example, a location may be defined by global-positioning coordinates (“GPS”), governmentally assigned addresses (e.g., area codes, zip codes, etc.), natural landmarks, Cartesian coordinates indicating distance and direction, etc. Furthermore, as described herein, locations may correspond to additional characteristics. For example, a location may be defined as the “home” location of a user and/or user account. The external communication location may represent an area in which a user normally resided. A location may also correspond to an “external communication” location. An external communication location may be the location of a communication that is received (or delivered). A location may also correspond to a “temporary” location. A temporary location may be the location temporarily assigned to a user and/or user account. The system may use a location (e.g., a home or temporary) to determine a time zone and/or processing time offset for a given external communication.

For example, in FIG. 1, user device 104 may be scheduled to receive an external communication at 7:00 PM EST (e.g., in time zone 108). This may be a targeted delivery time established by the system (e.g., a delivery time associated with a high rate of receipt and/or acknowledgement success). However, if server 102 is currently in a different geographic location (e.g., time zone 110), which is in a different time zone, an external communication sent at 7:00 PM PST may be received at 10:00 PM EST, which may conflict with a delivery rule. For example, if the system transmits the external communication at the designated time (i.e., 7:00 PM EST) according to time zone 110, the user may receive the external communication at 10:00 PM PST (e.g., while sleeping). Accordingly, the external communication may not be responded to or may be lost among other messages received during the night. However, if the system delays the external communication this issue may be averted. For example, by changing the delivery time of the external communication to 4:00 PM PST, the user may receive the external communication at the determined time—improving the likelihood of a successful external communication. To change the delivery time, the system may apply a processing time offset (either positive or negative to the delivery time).

For example, some external communication may be required to be sent at specific times and/or prevent from being sent at specific times. The system may therefore ensure that these specific times are met (relative to the local time of the user). For example, the system may apply a positive processing time offset or a negative processing time offset based on an external communication location of the user (and/or the local time zone of the temporary location). The system may then maintain the external communication location of the user for a certain time period and/or until certain criteria are met.

For example, the system may maintain an external communication location for a user account until a determined communication location for a subsequent communication corresponds to the external communication location. In some embodiments, the system may use one or more additional factors or criteria to determine whether or not to maintain or change to a temporary location or revert back to an external communication location to a user and/or user account. For example, the system may first determine a number of communications corresponding to communication locations that do not correspond to the temporary location. The system may then compare the number to a threshold number, and the system may determine a new temporary location (or revert back to the external communication location) for the first user account based on the external communication location based on the number equaling or exceeding the threshold number. In such cases, the system may only assign a new temporary location or revert back to the external communication location if a certain number of communications have been received from outside the temporary location or in the external communication location. Additionally or alternatively, the system may first determine a frequency of communications corresponding to communication locations that do not correspond to the temporary location. The system may then compare the frequency to a threshold frequency. The system may then determine the new temporary location (or revert back to the external communication location) for the first user account based on the external communication location based on the frequency equaling or exceeding the threshold frequency. In such cases, the system may only assign a new temporary location if communications have been received from outside the temporary location (or from the external communication location) at a certain frequency.

Additionally or alternatively, the system may modify the aforementioned factors or criteria based on a number of users that are authorized to perform communications (e.g., credit card transactions). For example, the system may only assign a new temporary location to one user (e.g., a first person of a couple) based on communications (e.g., credit card transactions) being received from a sub-account associated with that user. Likewise, the system may increase or decrease the thresholds discussed above based on the number of users associated with an account. Additionally or alternatively, the system may first determine an external communication characteristic based on the metadata (e.g., whether or not the external communication was a “card not present” credit card transaction). The system may then compare the external communication characteristic to communication characteristics that indicate a user corresponding to the first user account is outside of the external communication location (e.g., a “card present” credit card transaction, a travel booking transaction, location data, etc.) to determine whether to compare the external communication location to the external communication location.

For example, in some embodiments, a communication may comprise a credit card transaction. A credit card transaction may include metadata that describes the transaction. As referred to herein, user record data may include any data related to a transaction. For example, the record data may include a paper or electronic record containing information about the transaction, such as transaction amount, transaction number, transaction date and time, transaction type (deposits, withdrawal, purchase or refund), type of account being debited or credited, card number, identity of the card acceptor (e.g., merchant/source, including source address, identification or serial number, and/or terminal (e.g., name from which the terminal operates)).

The system may then use this information to determine whether or not a user is in a temporary location. For example, a merchant ID may include a corresponding address (e.g., a geographical address). Additionally, the record data may indicate whether or not a card was present. For example, if a card was present, the record data is indicative of a user being in the location of the external communication. However, if the card is not present, the record data is not indicative of a user being in the location of the external communication. For example, when a transaction occurs, the point-of-sale terminal may record whether or not the card was present (e.g., swiped, inserted, etc.).

Additionally or alternatively, the system may look for a category associated with the merchant ID. For example, some “card not present” transactions may be used to determine a temporary location of a user (e.g., a travel booking, food delivery order, etc.). The system may use merchant data and compare it to a database (e.g., a white list) to determine this. Additionally, alternative information may also be used. For example, a merchant name or ID that includes certain characters (e.g., “DD*”) may correspond to an alphanumeric code that indicates a merchant that facilitates remote delivery.

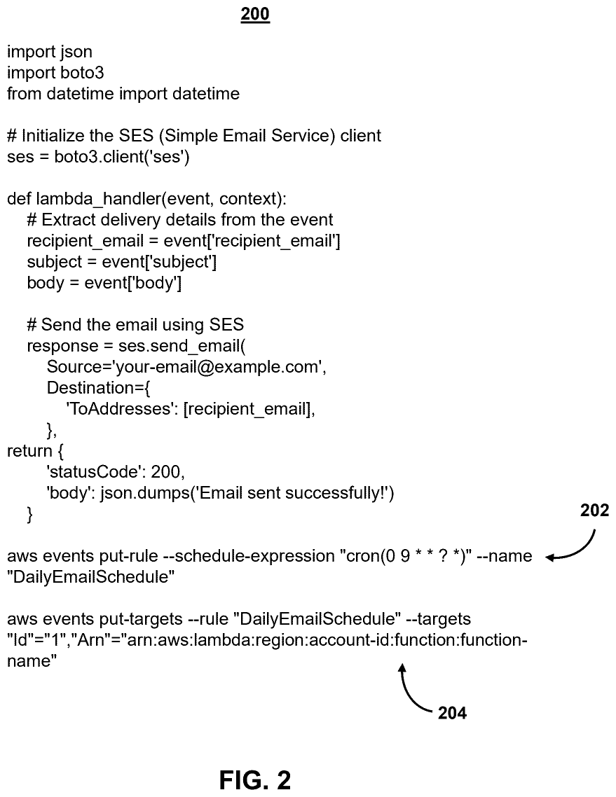

FIG. 2 shows an illustrative lambda function for queuing external communications, in accordance with one or more embodiments. For example, pseudocode 200 may comprise a system for queuing external communications using lambda functions. For example, pseudocode 200 for a lambda function for scheduling a delivery time to send an email at a specific time based on a delivery rule.

A lambda function may be a small, single-purpose piece of code that runs in response to specific events within a cloud computing environment. The lambda function may operate under a serverless architecture, meaning that the underlying infrastructure is entirely managed by a cloud computing platform, allowing developers to focus solely on writing the function's code. When an event triggers a lambda function—such as an HTTP request, a change in a database, or a scheduled time—the function executes its code to handle the event. This might involve processing data, interacting with other AWS services, sending notifications, or any number of other tasks.

Lambda functions are highly scalable and can handle a few requests per day to thousands of requests per second, automatically adjusting the required resources. They support multiple programming languages, including Python, Node.js, Java, C#, and Go, making them versatile for various applications. Since Lambda is stateless, it does not retain data between executions, which encourages efficient, modular design. Additionally, the pay-as-you-go pricing model means that users are only charged for the compute time their functions consume, down to the millisecond, without needing to maintain idle resources. This makes lambda functions a cost-effective and flexible solution for building and deploying applications in the cloud.

Pseudocode 200 may comprise triggering function 202. For example, triggering function 202 may trigger the function at 9:00 AM UTC every day. For example, a triggering function for a lambda function is an event or action that initiates the execution of the lambda function's code. This trigger can originate from a variety of sources and services within the cloud computing ecosystem, enabling a lambda function to respond to numerous types of events seamlessly. For instance, an HTTP request received through an API gateway can trigger a lambda function to handle web requests and API calls.

Triggering function 202 may trigger lambda functions to respond to database changes in real-time, while event rules can schedule triggers to execute functions at specific times or intervals. This event-driven architecture allows lambda functions to be highly responsive and efficient, executing only when specific conditions are met or actions occur, thus optimizing resource usage and operational costs. By leveraging various triggers, developers can build dynamic and scalable applications that react instantly to changes and events in their environment.

For example, pseudocode 200 includes an event rule that indicates that the external communication may only be sent at specific times according to a local time (e.g., event rule 204). For example, an event rule (or event data) may be used to trigger a lambda function. An event rule for a triggering function for a lambda function may be a defined condition or set of conditions that determine when the lambda function should (or should not) be executed. These rules are typically configured within event sources, which monitor and respond to various events across cloud services. For example, an event rule can be set up to trigger a lambda function at a specific time each day (or outside a time window each day), using a cron or rate expression to define the schedule. This allows for tasks like daily data processing, automated backups, or regular maintenance activities to be performed automatically at specified intervals.

Event rules can also be configured to respond to specific changes or actions within cloud services. For instance, an event rule might be set to trigger a lambda function whenever a new object is uploaded to object storage, enabling real-time processing or analysis of the uploaded data. Similarly, a rule can trigger a function in response to changes in a data table, such as the addition, modification, or deletion of records, facilitating immediate reaction to database updates. By setting event rules, users can precisely control the conditions under which their lambda functions are invoked, ensuring that the functions execute only when necessary. This enhances the efficiency and responsiveness of applications, allowing for automated workflows and real-time processing based on specific events and schedules within the cloud environment.

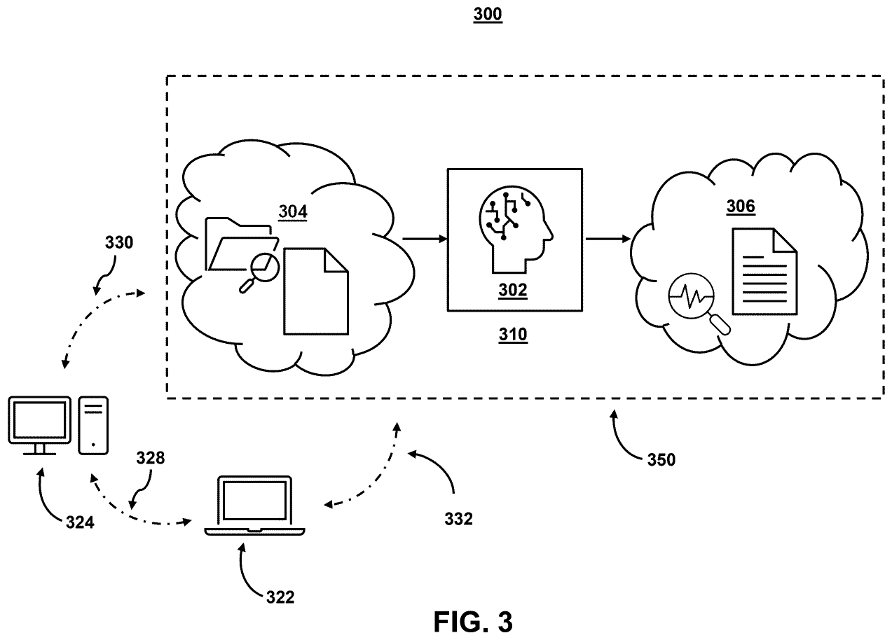

FIG. 3 shows illustrative components for a system used to queue external communications, in accordance with one or more embodiments. For example, FIG. 3 may show illustrative components for queuing external communications using internal lambda functions. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or external communications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or external communications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the model to classify a labeled feature input with the known prediction (e.g., a required delivery rule, an external communication location, a lambda function, a processing time offset, etc.).

For example, an artificial intelligence model may use historical information to generate training data by first collecting and aggregating relevant past data that reflects the scenarios it needs to learn and predict. This historical data serves as the foundation for creating a dataset that includes input features and known outcomes. For instance, if the goal is to train a model to determine delivery rules, the historical data might include records of previous deliveries, their times, locations, and any rules that were applied.

The process begins with data preprocessing, where the raw historical data is cleaned, normalized, and transformed into a structured format suitable for training. This involves handling missing values, removing duplicates, and converting categorical data into numerical formats if necessary. Once the data is preprocessed, it is divided into input features (such as timestamps, geographic locations, and communication types) and output labels (such as specific delivery rules or communication channels used).

For example, in training a model to classify a required delivery rule, the input features might include the day of the week, time of day, type of product, and customer location, while the output label would be the specific delivery rule applied in past instances. By feeding this structured historical data into a machine learning algorithm, the model learns patterns and relationships between the input features and the known outcomes.

The training process involves using techniques such as supervised learning, where the model iteratively adjusts its parameters to minimize the difference between its predictions and the actual known classifications. The model evaluates its performance using a portion of the data set aside as validation data to ensure it can generalize its predictions to new, unseen data.

Once trained, the model can predict classifications for new inputs by applying the learned patterns. For instance, it can determine the appropriate delivery rule for a new order, select an external communication location based on historical preferences, invoke a Lambda function at the right time, or apply a processing time offset. This ability to leverage historical data to train and enable models to make accurate and informed decisions, automating complex tasks and improving operational efficiency.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., a required delivery rule, an external communication location, a lambda function, a processing time offset, etc.).

In some embodiments, the model (e.g., model 302) may automatically perform actions based on outputs 306. In some embodiments, the model (e.g., model 302) may not perform any actions. The output of the model (e.g., model 302) may be used to queue external communications using internal lambda functions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

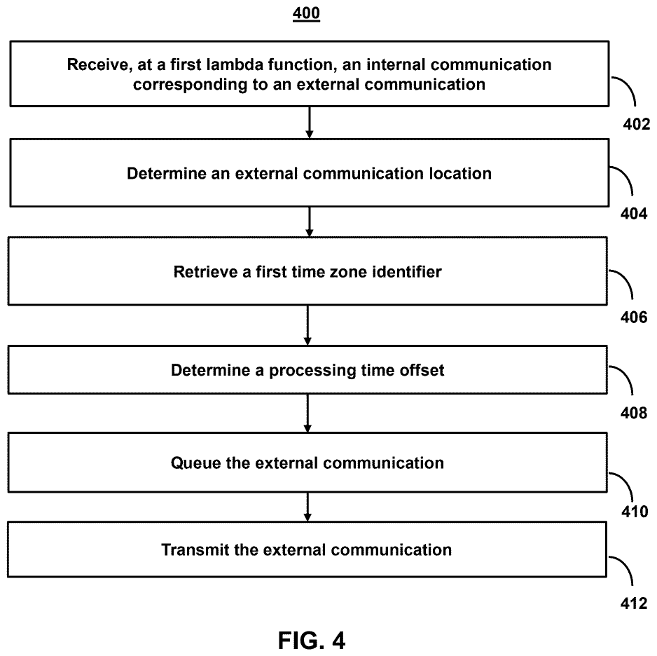

FIG. 4 shows a flowchart of the steps involved in queuing external communications using internal lambda functions, in accordance with one or more embodiments. For example, the system may use process 400 (e.g., as implemented on one or more system components described above) in order to queue external communications using internal lambda functions in order to limit communications to particular times. For example, the external communication may be an email communication (or a text message delivered using Short Message Peer-to-Peer Protocol (“SMPP”)) featuring metadata that comprises an IP address used to determine a geographical location corresponding to the IP address. In another example, the external communication may be based on an electronic account action (e.g., an overdraft notice, a missed payment notice, a default notice, etc.) for the first user account, wherein the metadata comprises location information for the electronic account action, and wherein the external communication location corresponds to a geographical location corresponding to the location information.

At step 402, process 400 (e.g., using one or more components described above) receives, at a first lambda function, an internal communication corresponding to an external communication. For example, the system may receive, at a first lambda function, an internal communication corresponding to an external communication, wherein the external communication is for delivery to a first user account, wherein a time of delivery for the external communication is based on an external communication location. For example, the external communication may be generated, such as an email or notification, which is intended for delivery to a specific user account. When the external communication is created (or received), it triggers an event within the system, which is captured by the first lambda function. This function acts as an intermediary, processing the event data and preparing it for further actions.

In some embodiments, receiving, at the first lambda function, the internal communication corresponding to the external communication the system may receive a first rule for delivery of the external communication and determine to use the first lambda function to enforce the first rule. When an external communication, such as an email or notification, is generated for delivery to a specific user account, it triggers an event within the system. This event is captured and processed by an intermediary service, such as an API gateway or an event management service. The event may include details about the external communication, such as the recipient's information, the content, and metadata including any relevant delivery rules. These delivery rules dictate when and how the communication should be delivered, ensuring compliance with user preferences and regulatory requirements. Upon receiving this event, the system identifies that a specific rule must be applied for the delivery of the external communication. This rule is part of the internal communication data that is passed to the first Lambda function. The internal communication includes all necessary information, such as the recipient's user account details, the content of the external communication, and the specific delivery rule that needs to be enforced. For example, the first Lambda function is triggered by this internal communication event. It acts as the logic processor to enforce the delivery rule. The function examines the delivery rule, which might specify conditions such as delivery time windows, geographical considerations, or other contextual factors. Based on this rule, the lambda function performs necessary calculations or lookups, such as determining the recipient's local time zone, checking for any delivery restrictions, and adjusting the delivery schedule accordingly. Once the appropriate delivery time and method are determined, the lambda function schedules the external communication for delivery.

In some embodiments, receiving, at the first lambda function, the internal communication corresponding to the external communication may comprise the system receiving a first event data corresponding to the internal communication, receiving the first event data at a stateless container corresponding to the first lambda function, and processing the first event data using logic of the stateless container. For example, the first event data may include comprehensive information about the external communication and any specific instructions or rules that need to be enforced for its delivery. The event-driven architecture ensures that this data is efficiently routed to the appropriate processing component. Upon creation, the first event data is received by a stateless container that corresponds to the first lambda function. In a cloud computing platform, each function operates within a stateless container, meaning it does not retain any information between executions. This design ensures scalability and efficient handling of requests. The stateless container associated with the lambda function is invoked by the incoming event data. Once the first event data is received by the stateless container, the lambda function processes the data using its predefined logic. This logic includes examining the details of the event data, such as the recipient's time zone, delivery preferences, and any regulatory constraints. The function applies the necessary calculations or decisions based on this information to determine the optimal delivery time and method for the external communication.

In some embodiments, receiving, at the first lambda function, the internal communication corresponding to the external communication may comprise the system receiving the internal communication at a serverless computing service and processing the internal communication using an object storage accessible to the serverless computing service. Once the internal communication data is stored, an event is generated by the object storage service, signaling that new data is available for processing. This event is configured to trigger the first lambda function. The serverless computing service responds to this event by invoking the corresponding lambda function. The lambda function runs within a stateless container, meaning it does not retain any data between executions and relies on the event data and accessible resources for processing. Upon invocation, the lambda function accesses the internal communication data stored in the object storage.

At step 404, process 400 (e.g., using one or more components described above) determines an external communication location. For example, the system may determine, while the internal communication is pending at the first lambda function, an external communication location based on metadata for the external communication. For example, the internal communication received by the lambda function may include metadata about the external communication, such as the recipient's user account, the content, and crucially, the external communication location, which determines the appropriate delivery time. For example, the metadata may include essential details, including the recipient's information and the content to be delivered. For example, the system may determine an external communication characteristic based on the metadata and compare the external communication characteristic to communication characteristics that indicate a user, user device, time zone, etc. corresponding to the first user account and/or external communication.

In some embodiments, the external communication location may be dynamically determined. For example, the location may be based on a home location for a user account, a currently determined location of a user (or user device), and/or another location as determined by the metadata. For example, the system may determine, while the internal communication is pending at the first lambda function, a temporary location for the first user account based on the external communication location. The system may then retrieve, while the internal communication is pending at the first lambda function, a second time zone identifier corresponding to the temporary location.

For example, the system may determine the external communication location based on the metadata for the external communication by determining a number of communications corresponding to communication locations that correspond to the external communication location, comparing the number to a threshold number, and determining the external communication location for the first user account based on the number exceeding the threshold number. For example, when an external communication is generated, its metadata is collected and analyzed. This metadata includes details such as the sender's location, the recipient's location, and any relevant tags or identifiers that indicate the communication's origin or destination. The system may first aggregate all communications related to the potential communication locations. It identifies and counts the number of past communications corresponding to each potential location associated with the external communication. For instance, if the system is evaluating multiple branches or offices of a company, it will tally the number of communications sent to or from each of these locations. The system may compare these counts against a predefined threshold number. This threshold represents the minimum number of communications required for a location to be considered significant or primary for the external communication. For example, if the threshold is set at 100 communications, any location with a count exceeding this number is considered a candidate for the external communication location. The system then determines the external communication location for the first user account by identifying the location with a number of communications that exceeds the threshold. If multiple locations surpass the threshold, the system might use additional criteria, such as the most recent communication or the highest count, to make the final determination. This ensures that the chosen location is the one most frequently associated with the external communication, reflecting the user's likely preference or the operational pattern.

In some embodiments, the system may determine the external communication location based on the metadata for the external communication by determining a frequency of communications corresponding to communication locations that correspond to the external communication location, comparing the frequency to a threshold frequency, and determining the external communication location for the first user account based on the frequency exceeding the threshold frequency.

For example, the system may collect metadata from the external communication, which includes information about the potential communication locations associated with the user account. The system may begin by identifying and aggregating all past communications related to each potential communication location. This involves examining the metadata to count the occurrences of communications for each location. For example, the system might track how many emails, notifications, or messages have been sent to or from each location over a specific period. The system may calculate the frequency of these communications for each location. Frequency, in this context, refers to how often communications occur over a given timeframe. For instance, the system might determine that one location has an average of 50 communications per week, while another has 30 communications per week. The system then compares these frequencies against a predefined threshold frequency. This threshold represents the minimum communication frequency required for a location to be considered significant. For example, if the threshold frequency is set at 40 communications per week, any location with a communication frequency exceeding this value is deemed a candidate for the external communication location. Based on this comparison, the system determines the external communication location for the first user account. The location with a communication frequency that exceeds the threshold frequency is selected. If multiple locations surpass the threshold, the system may choose the location with the highest frequency or apply additional criteria to make the final determination. This ensures that the chosen location is the one most frequently used for communications, reflecting the user's likely preference or operational pattern.

In some embodiments, the system may determine whether location data is available from a first user device corresponding to the first user account, and, in response to determining that the location data is available from the first user device, update the external communication location based on the location data. For example, the system may query the user device, which could be a smartphone, tablet, or another location-enabled device, to ascertain the availability of location data. This query might involve sending a request to the device's operating system or specific applications that manage location services. For example, upon receiving the request, the user device checks its settings and permissions to determine if location data can be accessed and shared. If location services are enabled and the necessary permissions are granted, the device retrieves the current location data, which typically includes latitude, longitude, and possibly additional contextual information like the device's accuracy and timestamp of the location data. The system then receives a response from the user device indicating whether location data is available. If the response confirms the availability of location data, the system proceeds to update the external communication location based on this newly acquired data. This involves capturing the location data from the user device and using it to adjust the external communication's destination or parameters accordingly. For instance, if the external communication involves delivering a notification or message that is location-sensitive, the system updates the communication to reflect the user's current location. This might mean recalculating the delivery time to match the user's time zone, altering the content to be more relevant to the user's current location, or redirecting the communication to a nearby service point or contact center.

At step 406, process 400 (e.g., using one or more components described above) retrieves a first time zone identifier. For example, the system may retrieve, while the internal communication is pending at the first lambda function, a first time zone identifier corresponding to the external communication location. The lambda function may use this location data to calculate the optimal delivery time based on predefined rules or algorithms that consider the recipient's time zone, local regulations, and/or user preferences. For instance, if the external communication location indicates that the recipient is in a different time zone, the lambda function may adjust the delivery time to ensure it aligns with the recipient's local business hours.

In some embodiments, the system may retrieve the external communication location based on account data for the first user account. The system may determine a geographic address based on the external communication location. The system may then determine the first time zone identifier based on the geographic address. The system may access the account data stored in a database or user profile service. This account data includes essential details such as the user's contact information, preferences, and location data, which might be specified as an address, city, postal code, or coordinates. Once the system retrieves the external communication location from the account data, it uses this information to determine the precise geographic address. If the location data is not already in a complete address format, the system may use geocoding services to convert partial data (like postal codes or city names) into a full address. Geocoding services, such as those provided by Google Maps API or other geographic information systems (GIS), can accurately translate these inputs into a comprehensive geographic address. With the geographic address determined, the system may proceed to identify the corresponding time zone. This is achieved by leveraging time zone databases or APIs, which map geographic locations to their respective time zones. For example, the system might use a service like the Google Time Zone API or the Time Zone Database (tz database) to query the time zone based on the geographic coordinates or address obtained from the previous step. In some embodiments, the time zone determination may involve sending a request to the chosen service, which includes the geographic address or coordinates. The service responds with the time zone identifier, such as “America/New_York” or ‘Europe/London,” representing the specific time zone for that geographic location. This identifier is crucial for scheduling communications accurately according to the recipient's local time.

At step 408, process 400 (e.g., using one or more components described above) determines a processing time offset. For example, the system may determine a processing time offset for the external communication based on the first time zone identifier. For example, once the delivery time is determined, the lambda function schedules the external communication for delivery at the calculated time. This may involve interacting with other cloud services for scheduling the communication. For example, the system may retrieve the first time zone identifier, which specifies the recipient's time zone, such as “America/New_York” or “Europe/London. ” Using this time zone identifier, the system calculates the current local time for the recipient. This calculation involves comparing the recipient's time zone to the system's standard or reference time zone, typically Coordinated Universal Time (UTC). The system then determines the processing time offset by identifying the difference in hours and minutes between the recipient's local time and the reference time. For example, if the system operates on UTC and the recipient is in the “America/New_York” time zone, which is UTC-5, the system calculates a-5 hour offset. This offset is used to adjust the timing of the external communication to ensure it aligns with the recipient's local business hours or preferred communication times. Once the processing time offset is determined, the system may apply this offset to schedule or delay the external communication accordingly. For instance, if the system needs to send an email at 9:00 AM local time for the recipient, it uses the offset to adjust the send time from the system's perspective. By incorporating the time zone offset into the scheduling logic, the system ensures that communications are delivered at the optimal time for the recipient, enhancing relevance and engagement.

At step 410, process 400 (e.g., using one or more components described above) queues the external communication. For example, the system may queue, at the first lambda function, the external communication in an internal communication queue based on the processing time offset.

In some embodiments, queuing the external communication in the internal communication queue may comprise the system retrieving the internal communication queue, wherein the internal communication queue is for a future time period and queuing the external communication in the internal communication queue. For example, the system may identify the external communication that needs to be delivered at a future time. This communication could be an email, notification, or any other form of message intended for a specific user account. The system starts by determining the correct internal communication queue for the future time period in which the external communication is scheduled to be delivered. This involves calculating or retrieving the desired delivery time based on various factors, such as user preferences, time zones, and regulatory constraints. Once the future time period is identified, the system locates or creates an internal communication queue corresponding to that specific time slot. These queues are typically organized in a way that allows for efficient scheduling and management of communications over time. After identifying the appropriate internal communication queue, the system retrieves it from the internal queue management service or database. This service maintains multiple queues, each designated for different future time periods, ensuring that communications are organized and can be processed at the right time. With the internal communication queue retrieved, the system proceeds to queue the external communication within it. This involves adding the external communication, along with any relevant metadata or instructions, to the queue. The metadata may include information such as the recipient's details, the content of the message, and the scheduled delivery time. The system ensures that the external communication is properly enqueued, maintaining the order and priority of messages if necessary. This queuing process allows the system to manage and process communications efficiently, ensuring they are delivered at the specified future time.

At step 412, process 400 (e.g., using one or more components described above) transmits the external communication. For example, the system may transmit, by the first lambda function, the external communication to the first user account. By doing so, the lambda function ensures that the external communication is delivered precisely when intended, optimizing the timing for maximum engagement and compliance with delivery rules.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for queuing external communications using internal lambda functions.
2. The method of any one of the preceding embodiments, the method comprising: receiving, at a first lambda function, an internal communication corresponding to an external communication, wherein the external communication is for delivery to a first user account, wherein a time of delivery for the external communication is based on an external communication location; determining, while the internal communication is pending at the first lambda function, an external communication location based on metadata for the external communication; retrieving, while the internal communication is pending at the first lambda function, a first time zone identifier corresponding to the external communication location; determining a processing time offset for the external communication based on the first time zone identifier; queuing, at the first lambda function, the external communication in an internal communication queue based on the processing time offset; and transmitting, by the first lambda function, the external communication to the first user account.
3. The method of any one of the preceding embodiments, wherein receiving, at the first lambda function, the internal communication corresponding to the external communication further comprises: receiving a first rule for delivery of the external communication; and determining to use the first lambda function to enforce the first rule.
4. The method of any one of the preceding embodiments, wherein receiving, at the first lambda function, the internal communication corresponding to the external communication further comprises: receiving a first event data corresponding to the internal communication; receiving the first event data at a stateless container corresponding to the first lambda function; and processing the first event data using logic of the stateless container.
5. The method of any one of the preceding embodiments, wherein receiving, at the first lambda function, the internal communication corresponding to the external communication further comprises: receiving the internal communication at a serverless computing service; and processing the internal communication using an object storage accessible to the serverless computing service.
6. The method of any one of the preceding embodiments, further comprising: determining, while the internal communication is pending at the first lambda function, a temporary location for the first user account based on the external communication location; and retrieving, while the internal communication is pending at the first lambda function, a second time zone identifier corresponding to the temporary location.
7. The method of any one of the preceding embodiments, further comprising: retrieving the external communication location based on account data for the first user account; determining a geographic address based on the external communication location; and determining the first time zone identifier based on the geographic address.
8. The method of any one of the preceding embodiments, wherein the external communication is an email communication, wherein the metadata comprises an IP address, and wherein the external communication location corresponds to a geographical location corresponding to the IP address.
9. The method of any one of the preceding embodiments, wherein the external communication is a text message delivered using Short Message Peer-to-Peer Protocol (“SMPP”).
10. The method of any one of the preceding embodiments, wherein the external communication is based on an electronic account action for the first user account, wherein the metadata comprises location information for the electronic account action, and wherein the external communication location corresponds to a geographical location corresponding to the location information.
11. The method of any one of the preceding embodiments, wherein determining the external communication location based on the metadata for the external communication: determining a number of communications corresponding to communication locations that correspond to the external communication location; comparing the number to a threshold number; and determining the external communication location for the first user account based on the number exceeding the threshold number.
12. The method of any one of the preceding embodiments, wherein determining the external communication location based on the metadata for the external communication: determining a frequency of communications corresponding to communication locations that correspond to the external communication location; comparing the frequency to a threshold frequency; and determining the external communication location for the first user account based on the frequency exceeding the threshold frequency.
13. The method of any one of the preceding embodiments, further comprising: determining an external communication characteristic based on the metadata; and comparing the external communication characteristic to communication characteristics that indicate a user corresponding to the first user account.
14. The method of any one of the preceding embodiments, wherein receiving the external communication for delivery to the first user account further comprises: retrieving the internal communication queue, wherein the internal communication queue is for a future time period; and identifying the external communication in the internal communication queue.
15. The method of any one of the preceding embodiments, further comprising: determining whether location data is available from a first user device corresponding to the first user account; and in response to determining that the location data is available from the first user device, updating the external communication location based on the location data.
16. One or more non-transitory, computer-readable mediums storing instructions that, when executed by a data processing apparatus, cause the data processing apparatus to perform operations comprising those of any of embodiments 1-15.
17. A system comprising one or more processors; and memory storing instructions that, when executed by the processors, cause the processors to effectuate operations comprising those of any of embodiments 1-15.
18. A system comprising means for performing any of embodiments 1-15.

What is claimed is:

1. A system for queuing external communications using internal lambda functions, the system comprising:
one or more processors; and
one or more non-transitory, computer-readable mediums comprising instructions that when executed by the one or more processors causes operations comprising:
receiving, at a serverless computing service, an internal communication corresponding to an external communication, wherein the external communication is for delivery to a first user account at a first user device, wherein a time of delivery for the external communication is based on an external communication location, and wherein the external communication location is based on a current geographic location of the first user device;
receiving a first rule for delivery of the external communication;
in response to receiving the internal communication, executing a first lambda function using a first stateless container at the serverless computing service to enforce the first rule, wherein the first lambda function performs operations comprising:
determining, while the internal communication is pending at the first stateless container, an external communication location based on metadata for the external communication;
retrieving, while the internal communication is pending at the first stateless container, a first time zone identifier corresponding to the external communication location;
determining a processing time offset for the external communication based on the first time zone identifier;
queuing the external communication in an internal communication queue based on the processing time offset; and
transmitting the external communication to the first user device.

2. A method for queuing external communications using internal lambda functions, the method comprising:
receiving, at a first lambda function, an internal communication corresponding to an external communication, wherein the external communication is for delivery to a first user account, wherein a time of delivery for the external communication is based on an external communication location;
determining, while the internal communication is pending at the first lambda function, an external communication location based on metadata for the external communication;
retrieving, while the internal communication is pending at the first lambda function, a first time zone identifier corresponding to the external communication location;
determining a processing time offset for the external communication based on the first time zone identifier;
queuing, at the first lambda function, the external communication in an internal communication queue based on the processing time offset; and
transmitting, by the first lambda function, the external communication to the first user account.

3. The method of claim 2, wherein receiving, at the first lambda function, the internal communication corresponding to the external communication further comprises:
receiving a first rule for delivery of the external communication; and
determining to use the first lambda function to enforce the first rule.

4. The method of claim 2, wherein receiving, at the first lambda function, the internal communication corresponding to the external communication further comprises:
receiving a first event data corresponding to the internal communication;
receiving the first event data at a stateless container corresponding to the first lambda function; and
processing the first event data using logic of the stateless container.

5. The method of claim 2, wherein receiving, at the first lambda function, the internal communication corresponding to the external communication further comprises:
receiving the internal communication at a serverless computing service; and
processing the internal communication using an object storage accessible to the serverless computing service.

6. The method of claim 2, further comprising:
determining, while the internal communication is pending at the first lambda function, a temporary location for the first user account based on the external communication location; and
retrieving, while the internal communication is pending at the first lambda function, a second time zone identifier corresponding to the temporary location.

7. The method of claim 2, further comprising:
retrieving the external communication location based on account data for the first user account;
determining a geographic address based on the external communication location; and
determining the first time zone identifier based on the geographic address.

8. The method of claim 2, wherein the external communication is an email communication, wherein the metadata comprises an IP address, and wherein the external communication location corresponds to a geographical location corresponding to the IP address.

9. The method of claim 2, wherein the external communication is a text message delivered using Short Message Peer-to-Peer Protocol (“SMPP”).

10. The method of claim 2, wherein the external communication is based on an electronic account action for the first user account, wherein the metadata comprises location information for the electronic account action, and wherein the external communication location corresponds to a geographical location corresponding to the location information.

11. The method of claim 2, wherein determining the external communication location based on the metadata for the external communication further comprises:
determining a number of communications corresponding to communication locations that correspond to the external communication location;
comparing the number to a threshold number; and
determining the external communication location for the first user account based on the number exceeding the threshold number.

12. The method of claim 2, wherein determining the external communication location based on the metadata for the external communication further comprises:
determining a frequency of communications corresponding to communication locations that correspond to the external communication location;
comparing the frequency to a threshold frequency; and
determining the external communication location for the first user account based on the frequency exceeding the threshold frequency.

13. The method of claim 2, further comprising:
determining an external communication characteristic based on the metadata; and
comparing the external communication characteristic to communication characteristics that indicate a user corresponding to the first user account.

14. The method of claim 2, wherein queuing the external communication in the internal communication queue further comprises:
retrieving the internal communication queue, wherein the internal communication queue is for a future time period; and
queuing the external communication in the internal communication queue.

15. The method of claim 2, further comprising:
determining whether location data is available from a first user device corresponding to the first user account; and
in response to determining that the location data is available from the first user device, updating the external communication location based on the location data.

16. One or more non-transitory, computer-readable mediums comprising instructions that when executed by one or more processors causes operations comprising:
receiving, at a first lambda function, an internal communication corresponding to an external communication, wherein the external communication is for delivery to a first user account, wherein a time of delivery for the external communication is based on an external communication location;
determining, while the internal communication is pending at the first lambda function, an external communication location based on metadata for the external communication;
retrieving, while the internal communication is pending at the first lambda function, a first time zone identifier corresponding to the external communication location;
determining a processing time offset for the external communication based on the first time zone identifier;
queuing, at the first lambda function, the external communication in an internal communication queue based on the processing time offset; and
transmitting, by the first lambda function, the external communication to the first user account.

17. The one or more non-transitory, computer-readable mediums of claim 16, wherein receiving, at the first lambda function, the internal communication corresponding to the external communication further comprises:
receiving a first rule for delivery of the external communication; and
determining to use the first lambda function to enforce the first rule.

18. The one or more non-transitory, computer-readable mediums of claim 16, wherein receiving, at the first lambda function, the internal communication corresponding to the external communication further comprises:
receiving a first event data corresponding to the internal communication;
receiving the first event data at a stateless container corresponding to the first lambda function; and
processing the first event data using logic of the stateless container.

19. The one or more non-transitory, computer-readable mediums of claim 16, wherein receiving, at the first lambda function, the internal communication corresponding to the external communication further comprises:
receiving the internal communication at a serverless computing service; and
processing the internal communication using an object storage accessible to the serverless computing service.

20. The one or more non-transitory, computer-readable mediums of claim 16, wherein the instructions further cause operations comprising:
determining whether location data is available from a first user device corresponding to the first user account; and
in response to determining that the location data is available from the first user device, updating the external communication location based on the location data.
